(19) United States
(12) Patent Application Publication
(10) Pub. No.: US 2019/0201939 A1
(43) Pub. Date: Jul. 4, 2019

(54) FLUID SUPPLY DEVICE OF SUPPLYING FLUID IN CURTAIN FORM

(71) Applicant: SHARP KABUSHIKI KAISHA, Sakai City (JP)

(72) Inventor: KOHSHIROH TANIIKE, Sakai City (JP)

(21) Appl. No.: 16/232,074

(22) Filed: Dec. 26, 2018

(30) Foreign Application Priority Data
Dec. 28, 2017 (JP) 2017-254224

(51) Int. Cl. B08B 3/02; G02F 1/13; B08B 3/04; B08B 3/08

(52) U.S. Cl. CPC B08B 3/022; G02F 1/1303; G02F 2001/1316; B08B 3/08; B08B 3/041

(57) ABSTRACT

A curtain-formed fluid supply device includes a storing section storing fluid, an elongated slit through which the fluid stored in the storing section is supplied in a curtain form, at least three supply pipes that supply the fluid to the storing section, and flow control valve disposed at each of the at least three supply pipes and controls a flow amount of the fluid. One of the at least three supply pipes is connected to a middle section of the storing section with respect to an extending direction of the elongated slit and two of the at least three supply pipes are connected to two end sections of the storing section with respect to the extending direction.

### CROSS REFERENCE TO RELATED APPLICATION

This application claims priority from Japanese Patent Application No. 2017-254224 filed on Dec.28, 2017. The entire contents of the priority application are incorporated herein by reference.

### TECHNICAL FIELD

The technology described herein relates to a fluid supply device of discharging or ejecting liquid or gas in a curtain form.

### BACKGROUND

In producing a liquid crystal panel that is a component of a liquid crystal display device, a surface of a substrate is cleaned with cleaning liquid such as pure water to remove foreign obstacles adhering to the surface of the substrate. However, in the cleaning of the substrate, cleaning unevenness is often occurred.

To restrict occurrence of the cleaning unevenness on the surface of the substrate, the cleaning liquid is supplied evenly over the surface of the substrate. Specifically, the cleaning unevenness is restricted by ejecting the cleaning liquid in a liquid curtain form with an aqua jetting knife and ejecting the cleaning liquid in a liquid curtain form to restrict the cleaning unevenness. Such a technology is described in Unexamined Japanese Patent Application Publication No. 7-77677.

### SUMMARY

However, in supplying the cleaning liquid in a curtain form, a gap may be created in a section of the cleaning liquid stream of a curtain form as illustrated in FIG. 5. Such a gap is created because of lack of the flow amount of the cleaning liquid. The lack of the flow amount of the cleaning liquid occurs from unbalance of ejection pressure of an ejection hole, which is a slit, as a whole. A substrate has been increased in size recently and the ejection hole (a slit) through which the cleaning liquid is ejected is elongated. According to the elongation of the ejection hole, the discharge pressure for ejecting the cleaning liquid is less likely to be same at the section of the slit near the supply pipe and the section far from the supply pipe. If the gap is created in the fluid stream, a portion of the substrate is uncleaned. Accordingly, the substrate may have an uncleaned portion of a linear shape or a belt shape and cleaning unevenness is caused. Such a partial uncleaned portion adversely influences the liquid crystal, display device and lowers the quality of the liquid crystal display device.

The technology described herein was made in view of the above circumstances. An object is to provide a fluid supply device of supplying fluid in a curtain form evenly without creating a gap in a fluid stream.

A curtain-formed fluid supply device according to the technology described herein includes a storing section staring fluid, an elongated slit through which the fluid stored in the storing section is supplied in a curtain form, at least three supply pipes that supply the fluid to the storing section, and a flow control valve disposed at each of the at least three supply pipes and controls a flow amount of the fluid. One of the at least three supply pipes is connected to a middle section of the storing section with respect to an extending direction of the elongated slit and two of the at least three supply pipes are connected to two end sections of the storing section with respect to the extending direction.

According to such a configuration, if the storing section and the slit are elongated according to increase of the substrate in size, the supply device includes multiple supply pipes that supply fluid to the storing section and the supply pipes are spaced from each other in the extending direction of the slit and connected to the storing section dispersedly. Furthermore, each of the supply pipes includes the flow control valve and the flow amount of the fluid is controlled by the flow control valve such that the flow amount of the fluid supplied to each of the supply pipes is equal. Therefore, the fluid is supplied to the storing section evenly as a whole. Therefore, the flow amount of the fluid supplied from the storing section through the slit can be kept uniform over an entire area of the slit in the extending direction and a gap is less likely to be caused in the curtain-shaped fluid stream.

Incidentally, at the end portion of the storing section, not only the end portion and the end face but also a region adjacent to the end portion from the intermediate portion than the intermediate portion is included.

According to the technology described herein, the curtain-formed fluid supply device that can supply fluid evenly with less occurrence of a gap in a fluid stream.

### BRIEF DESCRIPTION OF THE DRAWINGS

FIG. 1 is a schematic view of a substrate processing device.

FIG. 2 is a schematic perspective view illustrating an IPA supply device that ejects IPA to a liquid crystal substrate.

FIG. 3 is a schematic plan view illustrating the IPA supply device that ejects IPA to the liquid crystal substrate.

FIG. 4 is a schematic plan view illustrating an air supply device that ejects air to a liquid crystal substrate.

FIG. 5 is a schematic plan view of illustrating a fluid supply device supplying fluid in a curtain form according to a prior art and the fluid supply device ejecting fluid to a liquid crystal substrate.

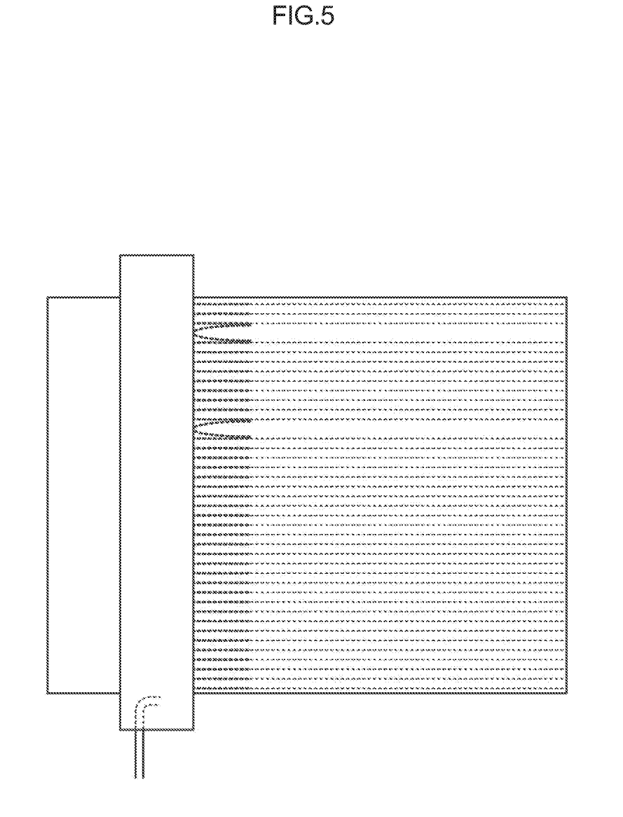

### DETAILED DESCRIPTION

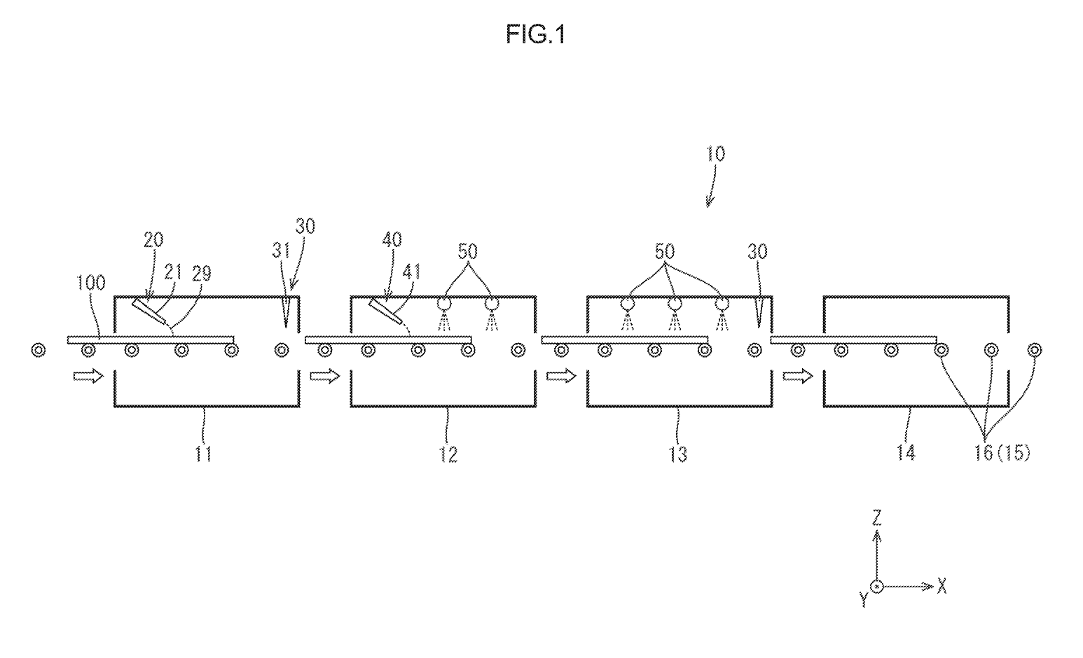

First to third embodiments of the present technology will be described with reference to FIGS. 1 to 4.

A curtain-formed fluid supply device according to the first to third embodiments is used for a substrate processing device 10 that cleans foreign obstacles such as minute dust or shavings adhering on a surface of a liquid crystal substrate 100. In the first to third embodiments, the liquid crystal substrate 100 is covered with a pretreatment material and the pretreatment material is subjected to replacement, treatment with pure water and cleaned with pure water. As illustrated in FIG. 1, the substrate processing device 10 includes treatment tanks.

In the following description, an X-axis direction in FIG. 1 is defined as a transferring direction of the liquid crystal substrate 100 (a front-rear direction), an Y-axis direction that is perpendicular to a paper surface is defined as a right-left direction (a width direction of the liquid crystal substrate 100 that is transferred), and a z-axis direction is defined as a vertical direction. In FIG. 1, a left side is an upstream side in the transferring direction and a right side is a downstream side in the transferring direction. In the substrate processing device 10, the liquid crystal substrate 100 is introduced into a tank from the upstream side in the transferring direction while a surface thereof where a thin film of pretreatment material is to be formed facing upward and the liquid crystal substrate 100 being in a horizontal state. The liquid crystal substrate 100 is transferred from the upstream side to the downstream side in the transferring direction by a transferring device 15 while a long side direction thereof being along the X-axis direction and a short side direction thereof being along the Y-axis direction.

As illustrated in FIG. 1, the substrate processing device 10 includes four treatment tanks including a film forming tank 11, a replacement tank 12, a cleaning tank 13, and a drying tank 14 in this order from the upstream side (the left side). The substrate processing device 10 includes the transferring device 15. The transferring device 15 includes transferring rollers 16 that transfer the liquid crystal substrate 100 with a driving source in the transferring direction (the X-axis direction). The liquid crystal substrate 100 is intermittently supported by the transferring rollers 16 that are contacted with a plate surface (a lower surface) of the liquid crystal substrate 100 opposite from a surface where a thin film of a pretreatment material is to be formed (an upper surface). Thus, the liquid crystal substrate 100 is transferred sequentially through each of the treatment tanks in the transferring direction by the transferring device 15 and is subjected to respective treatment in each treatment tank.

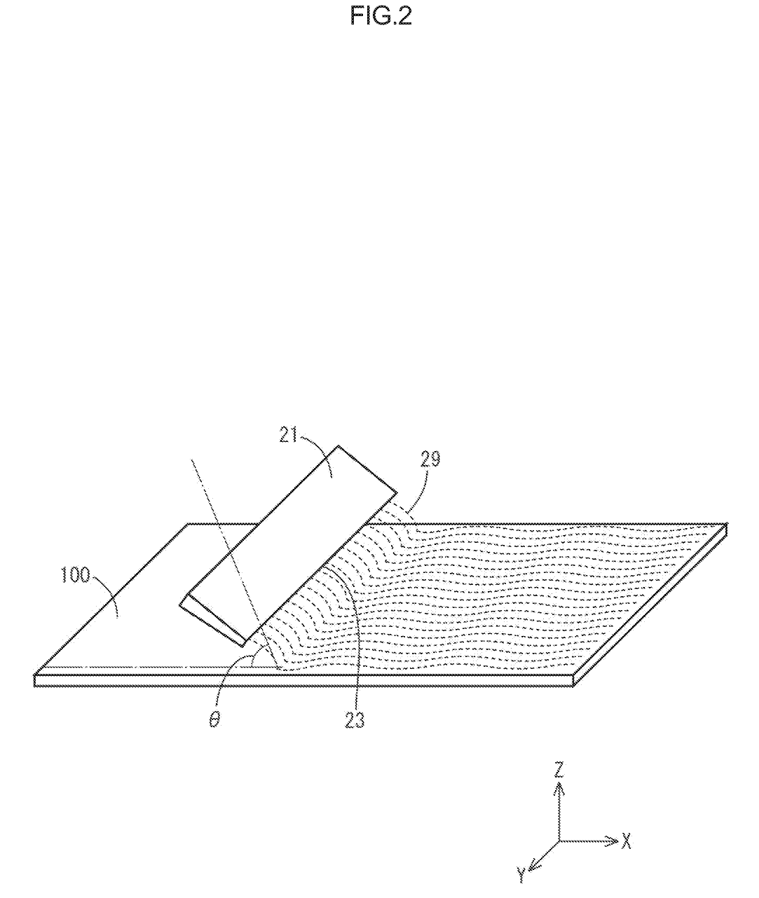

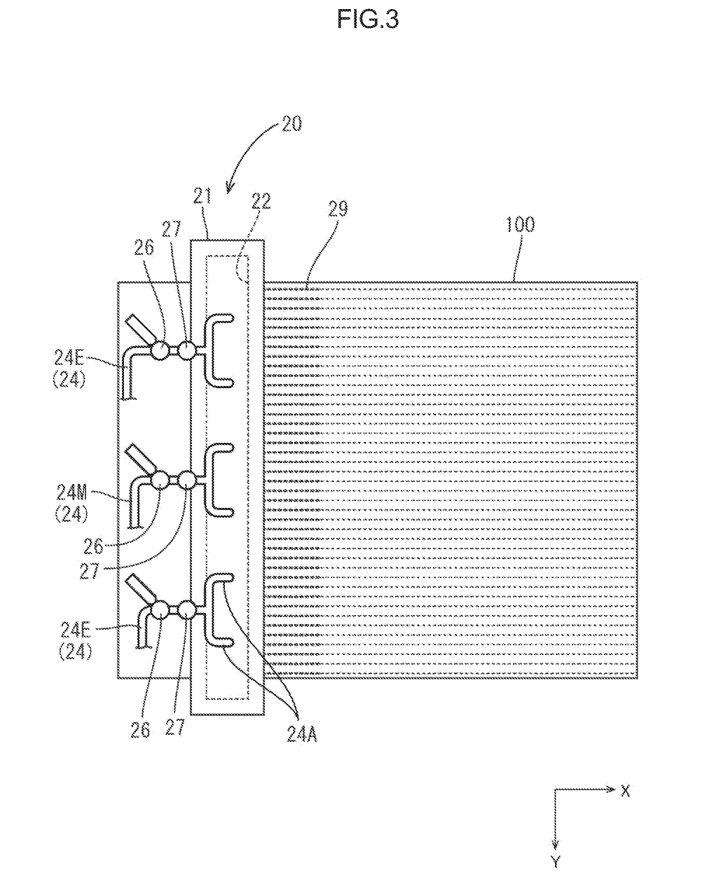

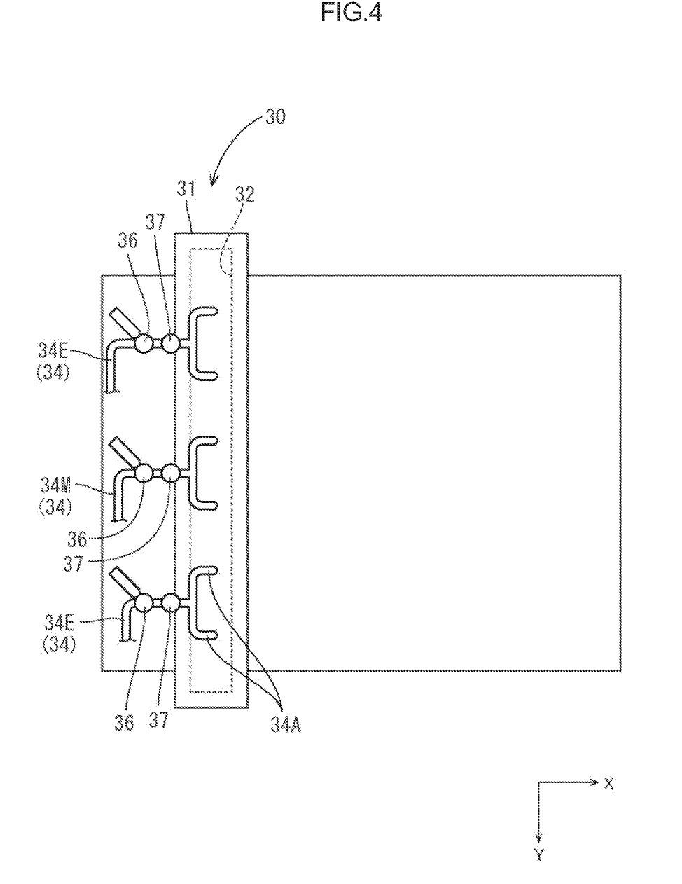

In FIGS. 1 and 2, supply pipes 24, 34, 44, which will be described layer, are not described to simplify the drawings. In FIGS. 3 and 4, directions of the supply pipes 24, 34 differ from actual directions.

In the first to third embodiments, the liquid crystal substrate 100 has a size of G4.5 to G6 and the transferring speed is 2000 mm/min to 3000 mm/min.

### First Embodiment

A curtain-formed fluid supply device according to the first embodiment is an IPA supply device 20 that is used in the film forming tank 11.

In the film forming tank 11, a thin film of isopropyl alcohol (IPA 29) is formed on the liquid crystal substrate 100 as a pretreatment material. In an upper section of the film forming tank 11 or an upper section of the liquid crystal substrate 100 introduced in the tank 11, an IPA knife 21 (IPA supply device 20) that is connected to an IPA supply pipe 24 is arranged. IPA 29 is ejected in a curtain form to the surface of the liquid crystal substrate 100 by the IPA knife 21. The IPA supply pipe 24 and the IPA knife 21 are formed from material that has been subjected to IPA resistance treatment.

The IPA knife 21 extends along a plate surface (an X-Y plane surface) of the liquid crystal substrate 100 and perpendicular to the transferring direction and includes an IPA storing section 22 therein. As illustrated in FIGS. 2 and 3, the IPA storing section 22 is elongated in a width direction (the Y-axis direction) of the liquid crystal substrate 100. The IPA knife 21 is tilted such that a lower section is disposed on the downstream side. The IPA storing section 22 has a long slit 23 on a lower edge surface along the extending direction (the Y-axis direction) of the storing section 22. IPA 29 is ejected through the slit 23 in a curtain form. The slit 23 is formed such that IPA 29 is ejected to the plate surface (the X-Y plane surface) of the liquid crystal substrate 100 at a certain angle θ toward the downstream side in the transferring direction (toward the right side in FIG. 1). Namely, the slit 23 is formed such that IPA 29 is ejected therethrough in a liquid curtain form. The angle θ is preferably within a range from 30° to 80°.

As illustrated in FIG. 3, the storing section 22 of the IPA knife 21 is connected to IPA supply pipes 24 (three pipes in this embodiment) that extend from the IPA storing tank that stores IPA 29 therein. Two of the IPA supply pipes 24 are a pair of end-side supply pipes 24E that are arranged at two end portions of the storing section 22 with respect to the extending direction (the Y-axis direction) of the slit 23. The other one of the IPA supply pipes 24 is a middle supply pipe 24M that is arranged in a middle section of the storing section 22 with respect to the extending direction of the slit 23.

Each of the (three) IPA supply pipes 24 (24E, 24M, 24E) extending from the IPA storing tank is branched into two at a distal end thereof and the distal end is formed in a U shape. Hereinafter, a branched section is referred to as a branch section 24A. Distal ends of the branch sections 24A are arranged in the extending direction of the slit 23 (the Y-axis direction) and are connected to supply holes of the storing section 22. More specifically, two branch sections 24A making a pair have same diameter and length and a same bent shape (a symmetric shape). The branch sections 24A are arranged in a line and connected to the storing section 22.

In this embodiment, the three pairs of branch sections 24A have a same shape and a same size. The supply holes (six supply holes in this embodiment) are arranged at equal intervals and the branch sections 24A are connected to the storing section 22 at equal intervals.

Furthermore, a flow control valve 26 is arranged on an IPA storing tank side of the branch section 24A of each IPA supply pipe 24E, 24M, 24E. A flow amount of IPA 29 through each of the IPA supply pipes 24E, 24M, 24E can be controlled by an opening/closing degree of the flow control valve 26. A flow meter 27 measuring a flow amount of IPA 29 is disposed next to each flow control valve 26.

IPA 29 is ejected from the IPA supply device 20 obliquely toward the downstream side of the transferring direction such that the IPA thin film is formed on an entire area of the upper surface of the liquid crystal substrate 100 almost evenly with less unevenness.

Next, operations and advantageous effects of the IPA supply device 20, which is the curtain-formed fluid supply device, according to the present embodiment will be described.

The IPA supply device 20 of the first embodiment includes the storing section 22 that stores IPA 29, the slit 23 through which IPA 29 stored in the storing section 22 is ejected in a curtain form, and the three IPA supply pipes 24 that supply IPA 29 to the storing section 22. The three IPA supply pipes 24 are connected to a middle section and two end sections of the storing section 22 with respect to the extending direction of the slit 23 (the Y-axis direction), respectively. Each of the supply pipes 24 includes the flow control valve 26 that controls the f low amount of IPA 29.

According to such a configuration, if the storing section 22 and the slit 23 are elongated according to increase of the liquid crystal substrate 100 in size, the IPA supply device 20 includes multiple IPA supply pipes 24 that supply IPA 29 to the storing section 22 and the IPA supply pipes 24 are spaced from each other in the extending direction (the Y-axis direction) of the slit 23 and connected to the storing section 22 dispersedly. Furthermore, each of the IPA supply pipes 24 includes the flow control valve 26 and the flow amount of IPA 29 is controlled by the flow control valve 26 such that the flow amount of IPA 29 to each of the IPA supply pipes 24 is equal. Therefore, IPA 29 is supplied to the storing section 22 evenly as a whole. Therefore, the flow amount of IPA 29 supplied from the storing section 22 through the slit 23 can be kept uniform over an entire area of the slit 23 in the extending direction (the Y-axis direction) and a gap is less likely to be caused in the curtain-shaped fluid stream.

Furthermore, the IPA supply pipe 24 of this embodiment symmetrically includes the branch sections 24A between the flow control valve 26 and the storing section 22. The branch sections 24A are arranged in the extending direction (the Y-axis direction) of the slit 23 and connected to the storing section 22. According to such a configuration, the number of the connection points of the storing section 22 and the IPA supply pipes 24 (the branch sections 24A) is increased while the number of the IPA supply pipes 24 extending from the supply source of IPA 29 (the IPA storing tank) to the vicinity of the storing section 22 being relatively small. Namely, IPA 29 can toe supplied evenly to the storing section 22 with a simple structure.

The IPA supply pipe 24 includes the flow meter 27 that measures the flow amount of IPA 29 and the opening/closing degree of the flow control valve 26 can be controlled while checking the flow meter 27. Therefore, IPA 29 can be supplied to the staring section 22 with a uniform flow amount.

According to the IPA supply device 20 of the first embodiment, IPA can be ejected evenly and a gap is less likely to be caused in a fluid stream.

### Second Embodiment

A curtain-formed fluid supply device according to a second embodiment is an air supply device 30 that is used in the film forming tank 11.

The film forming tank 11 includes an air jetting knife 31 (an air supply device 30) on a downstream side of the IPA knife 21 and near an exit of the film forming tank 11. The air jetting knife 31 is connected to air supply pipes 34. Similarly to the IPA knife 21, the air jetting knife 31 includes an air storing section 32 that extends along a plate surface (an X-Y plane surface) and perpendicular to the transferring direction and is elongated in a width direction of the liquid crystal substrate 100 (the Y-axis direction). The air storing section 32 has a slit on a lower surface thereof. Clean dry air (an example of fluid) is jet in a curtain form through the slit to the liquid crystal substrate 100. Unlike the IPA knife 21, the air jetting knife 31 is not slanted and arranged vertically to the liquid crystal substrate 100.

As illustrated in FIG. 4, the air storing section 32 of the air jetting knife 31 is connected to air supply pipes 34 (three air supply pipes in this embodiment) that extend from an air tank. The air supply pipes 34 of this embodiment have a configuration similar to that of the IPA supply pipes 24 of the first embodiment. Two of the air supply pipes 34 are a pair of end-side supply pipes 34E that are arranged at two end portions of the air storing section 32 with respect to the extending direction (the Y-axis direction) of the slit. The other one of the air supply pipes 34 is a middle supply pipe 34M that is arranged in a middle section of the air storing section 32 with respect to the extending direction of the slit. Each of the air supply pipes 34 (34E, 34M, 34E) is branched into two branch sections 34A at a distal end thereof and the branch sections 34A are arranged in the extending direction of the slit (the Y-axis direction) and are connected to the air storing section 32.

The air supply device 30 further includes flow control valves 36 and flow meters or pressure meters 37 on the air tank side than the branch sections 34A.

Air is jet vertically from the air jetting knife 31 to the liquid crystal substrate 100. Extra IPA 29 is removed by air jet from the air jetting knife 31 and the liquid crystal substrate 100 is covered with the IPA thin film almost evenly with less unevenness. Such a liquid crystal substrate 100 is transferred from the film forming tank 11 to the replacement tank 12 (refer FIG. 1).

According to the air supply device 30 according to the second embodiment, the flow amount of air f lowing through the air supply pipes 34 is controlled to be same by the flow control valves 36 such that pressure within the air storing section 32 as a whole can be uniform. Therefore, a flow amount of air jet from the air storing section 32 through the slit can be uniform over an entire area of the slit and the extra fluid can be removed effectively. Operations and advantageous effects similar to those of the first embodiment, can be obtained.

### Third Embodiment

A curtain-formed fluid supply device according to a third embodiment is a pure water supply device 40 that is used in the replacement tank 12.

The replacement, tank 12 includes an aqua jetting knife 41 (a pure water supply device 40) in an upper section within the replacement tank 12. The aqua jetting knife 41 is arranged above the liquid crystal substrate 100 that is transferred by the transferring device 15. The aqua jetting knife 41 is connected to pure water supply pipes. The pure water supply device 40 has a configuration same as that of the IPA supply device 20. However, material of the pure water supply device 40 is not subjected to an IPA-resistance treatment. Other configurations are similar to those of the IPA supply device 20 and will not be described. The pure water supply device 40 jets pure water (an example of fluid) for replacement to the liquid crystal substrate 100.

The replacement tank 12 includes nozzle-type showers 50 on a downstream side of the pure water supply device 40. The nozzle-type showers 50 are made of resin and have nozzles through which pure water for replacement is jet to the liquid crystal substrate 100. Each of the nozzle-type showers 50 extends along a plate surface of the liquid crystal substrate 100 and extends linearly and perpendicular to the transferring direction (the Y-axis direction). Two to four nozzle-type showers 50 (two in this embodiment) are arranged parallel to each other and in the transferring direction. IPA 29 is replaced with pure water supplied to the surface of the liquid crystal substrate 100 and an entire surface of the substrate is covered with pure water.

According to such a pure water supply device 40 of the third embodiment, the operations and advantageous effects similar to those of the IPA supply device 20 of the first embodiment are obtained.

After the surface of the liquid crystal substrate 100 is subjected to the pure water replacement in the replacement tank 12, the liquid crystal substrate 100 is transferred to the cleaning tank 13 by the transferring device 15. The cleaning tank 13 includes the nozzle-type showers 50, which are same as those in the replacement tank 12, in an upper section thereof and above the liquid crystal substrate 100 that is transferred to the cleaning tank 13. Each nozzle-type shower 50 extends perpendicular to the transferring direction. The nozzle-type showers 50 (three in this embodiment) are arranged parallel to each other and in the transferring direction. The liquid crystal substrate 100 is cleaned with high pressure with pure water jet from the nozzle-type showers 50 and foreign obstacles are removed from the surface of the liquid crystal substrate 100.

The cleaning tank 13 includes the air supply device 30 similar to that in the film forming tank 11 near an exit of the cleaning tank 13. After extra fluid on the liquid crystal substrate 100 is removed by the air jetting knife 31 of the air supply device 30, the liquid crystal substrate 100 is transferred to the drying tank 14 by the transferring device 15. Moisture that is absorbed in the liquid crystal substrate 100 and has not been removed by the air jetting knife 31 is completely removed in the drying tank 14. After drying at high temperature, the liquid crystal substrate 100 is discharged from the substrate processing device 10.

According to the IPA supply device 20, the air supply device 30, and the pure water supply device 40 of the first to third embodiments, a gap is less likely to be caused in a stream of liquid or gas and fluid can be supplied evenly.

### Other Embodiments

The technology described herein is not limited to the embodiments described in the above sections and the drawings. For example, the following embodiments may be included in a technical scope.

(1) The curtain-formed fluid supply device of the present technology may not be necessarily included in the substrate processing device and may be included any other devices.

(2) The supply pipe may not include the branch sections at the distal end thereof.

(3) The branch sections may not arranged along the extending direction of the slit.

(4) The flow control valve may be included at each branch section.

(5) Four or more supply pipes may be included.

(6) IPA and pure water may be ejected vertically or obliquely toward the upstream side from the IPA knife 21 and the aqua jetting knife 41.

(7) Air maybe jet obliquely from the air jetting knife 31.

(8) The end-side supply pipes may be connected to the storing section at portions different from the portion to which the middle supply pipe is connected.

(9) The number of the cleaning tanks may be two or more.

(10) Cleaning tanks may be defined in one tank.

(11) The cleaning tank may include a ultrasonic shower, bubble jetting, cavitation jetting, high-pressure spray shower, and a two-fluid type according to a desired effect of removal of foreign obstacles.

1. A curtain-formed fluid supply device comprising:
a storing section storing fluid;
an elongated slit through which the fluid stored in the storing section is supplied in a curtain form;
at least three supply pipes that supply the fluid to the storing section, one of the at least three supply pipes being connected to a middle section of the storing section with respect to an extending direction of the elongated slit and two of the at least three supply pipes being connected to two end sections of the storing section with respect to the extending direction; and
a flow control valve disposed at each of the at least three supply pipes and controls a flow amount of the fluid.

2. The curtain-formed fluid supply device according to claim 1, wherein
each of the at least three supply pipes includes two branch sections between the flow control valve and the storing section and the two branch sections have symmetric forms, and
the branch sections are arranged in the extending direction and connected to the storing section.

3. The curtain-formed fluid supply device according to claim 1, further comprising a flow meter or a pressure meter disposed at each of the at least three supply pipes.
